(19) United States
(12) Patent Application Publication
(10) Pub. No.: US 2025/0116976 A1
(43) Pub. Date: Apr. 10, 2025

(54) SYSTEMS AND METHODS FOR CONTROLLING COMPLEX SYSTEMS

(71) Applicant: Michael Glinsky, Santa Fe, NM (US)

(72) Inventor: Michael Glinsky, Santa Fe, NM (US)

(21) Appl. No.: 18/906,844

(22) Filed: Oct. 4, 2024

Related U.S. Application Data
(60) Provisional application No. 63/588,176, filed on Oct. 5, 2023.

(51) Int. Cl. G05B 13/04; G06F 17/11

(52) U.S. Cl. CPC G05B 13/041; G06F 17/11

(57) ABSTRACT

Controlling a complex system including: obtaining an input of a functional of field and co-field functions; determining, based on the input functional and using a canonical functional transformation, an input function; determining, based on the input function and using a function transformation, the input basic state and co-state variables; determining, based on the input basic state and co-state variables and using a canonical transformation, input fundamental state and co-state variables; determining, based on the input fundamental state and co-state variables and using a control function transformation, output fundamental state and co-state variables; determining, based on the output fundamental state and co-state variables and using an inverse canonical transformation, output basic state and co-state variables; determining, based on the output basic state and co-state variables and using a function transformation, the output function; and determining, based on the output function and using an inverse canonical functional transformation, an output functional of the field and co-field functions.

### RELATED APPLICATIONS

This application claims benefit of and priority to U.S. Provisional Patent Application No. 63/588,176 filed Oct. 5, 2023 and titled “SYSTEMS AND METHODS FOR CONTROLLING AND SIMULATING COMPLEX SYSTEMS,” the entirety of which is hereby incorporated by reference.

### FIELD

Embodiments relate generally to control of complex systems and more particularly to simulating, configuring, and deploying complex systems.

### BACKGROUND

Complex systems include stochastic systems that display behaviours at many scales that may self organize or display other emergent behaviours. It is not uncommon that the behaviour of complex systems is very discontinuous and that the natural emergent behaviours are not desirable. Examples of complex systems that may benefit from control include automobiles, rockets, robots, power systems, nuclear fission reactors, plasma physics systems (e.g., including fusion reactors), atomic systems, medical devices, business systems, aircraft, biochemical systems, ecosystems, social systems, social infrastructure, games, computer systems, financial systems, economic systems, and the like.

Existing systems and methods to characterize and control systems typically do not take into account the nature of a complex system as a collective of many individual systems, or the canonical structure of a complex system. For example, work of Bellman and Kalman (See, e.g., E. Kalman. The theory of optimal control and the calculus of variations. In Richard Bellman, editor, Mathematical Optimization Techniques, pages 309-331. University of California Press, 1963) addressed control of individual systems. Further, work by Silver et al. (See, e.g., Volodymyr Mnih, Koray Kavukcuoglu, David Silver, Andrei A Rusu, Joel Veness, Marc G Bellemare, Alex Graves, Martin Riedmiller, Andreas K Fidjeland, Georg Ostrovski, et al. Human-level control through deep reinforcement learning. Nature, 518 (7540): 529-533, 2015) on Deep Q-Learning or Deep Reinforcement Learning (DRL), and by Radford et al. (See, e.g., Alec Radford, Karthik Narasimhan, Tim Salimans, and Ilya Sutskever. Improving language understanding by generative pre-training. openAI.com, 2018) and Vaswani (See, e.g., A Vaswani. Attention is all you need. Advances in Neural Information Processing Systems, 2017) on Generative Pretrained Transformers (GPT) have not correctly structured functional approximators (e.g., convolution neural networks) to capture the canonical structure of complex systems. Indeed, certain aspects of their functional approximators are constrained away from a conservative structure, such as a canonical structure.

### SUMMARY

Certain control system control approaches, such as that pioneered by Bellman and Kalman, is for individual systems in what is referred to as the basic ROM domain. These have generally isolated singularities β* (that is, natural frequencies). A complication with collective (or complex) systems of many individuals is that they have singularity spectrums β (z) (that is, natural frequency spectrums). Embodiments address this with a complex transformer that, for example, calculates singularity spectrums β (z), which can be especially useful for controlling a complex system.

Complex or collective systems are collectives or ensembles of conservatively interacting entities. What one individual loses, others gain. This does not exclude the possibility of external interactions. Although, at the core, these systems are analytic, holomorphic, or complex, they also display simple emergent behaviors. Complex systems take many different forms. A plasma is a collective system of charged particles, a fluid is a collective system of molecules, a field is a collective system of elementary particles, a cosmos is a collective system of celestial bodies, a novel is a collective system of letters, a society is a collective system of individuals, and an economy is a collective system of economic entities (e.g., people, families, villages, countries, and companies) that engage in trade.

Provided are techniques for improved control and simulation of complex systems. Certain embodiments are based on a novel theory of collective behavior, comprising of characterization, forecast (e.g., simulation), and control (e.g., including stabilization, and optimal system and experimental design) of the complex system.

Provided in some embodiments is a system for controlling a complex system including: a processor; and non-transitory computer readable storage medium comprising program instruction stored thereon that are executable by the processor to cause the following operations: obtaining an input of a functional of field and co-field functions; determining, based on the input functional and using a canonical functional transformation determined by a generating functional, an input function, the input function including a function of input basic state and co-state variables; determining, based on the input function and using a function transformation, the input basic state and co-state variables; determining, based on the input basic state and co-state variables and using a canonical transformation determined by a generating function that is a solution to a Hamilton-Jacobi equation, input fundamental state and co-state variables; determining, based on the input fundamental state and co-state variables and using a control function transformation, output fundamental state and co-state variables; determining, based on the output fundamental state and co-state variables and using an inverse canonical transformation determined by a generating function that is a solution to the Hamilton-Jacobi equation, output basic state and co-state variables; determining, based on the output basic state and co-state variables and using a function transformation, the output function, the output function including a function of output basic state and co-state variables; and determining, based on the output function and using an inverse canonical functional transformation determined by a generating functional, an output functional of the field and co-field functions, where a complex system operation is controlled based on the output functional of field and co-field functions.

Provided in some embodiments is a method of controlling a complex system including: obtaining an input of a functional of field and co-field functions; determining, based on the input functional and using a canonical functional transformation determined by a generating functional, an input function, the input function including a function of input basic state and co-state variables; determining, based on the input function and using a function transformation, the input basic state and co-state variables; determining, based on the input basic state and co-state variables and using a canonical transformation determined by a generating function that is a solution to a Hamilton-Jacobi equation, input fundamental state and co-state variables; determining, based on the input fundamental state and co-state variables and using a control function transformation, output fundamental state and co-state variables; determining, based on the output fundamental state and co-state variables and using an inverse canonical transformation determined by a generating function that is a solution to the Hamilton-Jacobi equation, output basic state and co-state variables; determining, based on the output basic state and co-state variables and using a function transformation, the output function, the output function including a function of output basic state and co-state variables; and determining, based on the output function and using an inverse canonical functional transformation determined by a generating functional, an output functional of the field and co-field functions, where a complex system operation is controlled based on the output functional of field and co-field functions.

Provided in some embodiments is a non-transitory computer readable storage medium comprising program instruction stored thereon that are executable by the processor to cause the following operations for controlling a complex system: obtaining an input of a functional of field and co-field functions; determining, based on the input functional and using a canonical functional transformation determined by a generating functional, an input function, the input function including a function of input basic state and co-state variables; determining, based on the input function and using a function transformation, the input basic state and co-state variables; determining, based on the input basic state and co-state variables and using a canonical transformation determined by a generating function that is a solution to a Hamilton-Jacobi equation, input fundamental state and co-state variables; determining, based on the input fundamental state and co-state variables and using a control function transformation, output fundamental state and co-state variables; determining, based on the output fundamental state and co-state variables and using an inverse canonical transformation determined by a generating function that is a solution to the Hamilton-Jacobi equation, output basic state and co-state variables; determining, based on the output basic state and co-state variables and using a function transformation, the output function, the output function including a function of output basic state and co-state variables; and determining, based on the output function and using an inverse canonical functional transformation determined by a generating functional, an output functional of the field and co-field functions, where a complex system operation is controlled based on the output functional of field and co-field functions.

In some embodiments, the canonical functional transformation determined by a generating functional includes: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection; the function transformations include: (1) a specified formula for a function; (2) a universal function approximator; or (3) a multi-layer perceptron (MLP) with rectified linear unit (ReLU) activation; the canonical transformation determined by a generating function that is a solution to a Hamilton-Jacobi equation includes: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder; the control function transformation includes: (1) a specified formula for a function; (2) a universal function approximator; (3) a multi-layer perceptron (MLP) with rectified linear unit (ReLU) activation; (4) a propagation function adapted to evolve the complex system; (5) a ponderomotive stabilization function adapted to stabilize unstable equilibriums of the complex system; (6) a feedback control function adapted to stabilize unstable equilibriums of the complex system; (7) a conservative force function adapted to optimize the performance, that is the design, of the complex system; or (8) a diffusive function adapted to cool, that is reduce the fluctuations, of the complex system; the inverse canonical transformation determined by a generating function that is a solution to the Hamilton-Jacobi equation includes: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder; and/or the inverse canonical functional transformation determined by a generating functional includes: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).

This description of systems and methods includes reference to physical collectives such as plasmas and fluids for the purpose of explanation. In particular, embodiments refer to examples concerning a fusion reactor, including, for example, control of plasma in the core of the fusion reactor. Although embodiments are described in certain context for the purpose of explanation, embodiments may be employed in any suitable context. For example, embodiments may be employed in the design and control of physical systems, such as automobiles, financial systems, or the like.

### BRIEF DESCRIPTION OF THE DRAWINGS

FIG. 1 is a diagram that illustrates a control environment in accordance with one or more embodiments.

FIG. 2 is a diagram that illustrates operational aspects of a controller in accordance with one or more embodiments.

FIG. 3 is a diagram that illustrates a complex transformer in accordance with one or more embodiments.

FIG. 4 is a diagram that illustrates a fundamental transformer in accordance with one or more embodiments.

FIG. 5 is a diagram that illustrates a neural network architecture in accordance with one or more embodiments.

FIG. 6 is a diagram that illustrates an addition to a neural network architecture to estimate a change in energy value in accordance with one or more embodiments.

FIG. 7 is a diagram that illustrates an addition to a neural network architecture to estimate external force in accordance with one or more embodiments.

FIG. 8 is a diagram that illustrates a representative contour plot for a physical system in accordance with one or more embodiments.

FIG. 9 is a diagram that illustrates value profiles in accordance with one or more embodiments.

FIG. 10 is a diagram that illustrates input and output variables of a control system workflow in accordance with one or more embodiments.

FIG. 11 is a diagram that illustrates a mathematical foundation of a complex transformer in accordance with one or more embodiments.

FIG. 12 is a diagram that illustrates an example embodiment of operational aspects of a controller of a complex system in accordance with one or more embodiments.

FIG. 13 is a diagram that illustrates an example embodiment of operational aspects a controller of a complex system in accordance with one or more embodiments.

FIG. 14 is a diagram that illustrates a universal field translator (UFT) in accordance with one or more embodiments.

FIG. 15 is a diagram that illustrates example embodiments of a UFT in accordance with one or more embodiments.

FIG. 16 is a diagram that illustrates an example computer system in accordance with one or more embodiments.

While this disclosure is susceptible to various modifications and alternative forms, specific example embodiments are shown and described. The drawings may not be to scale. The drawings and the detailed description are not intended to limit the disclosure to the form disclosed, but are intended to disclose modifications, equivalents, and alternatives falling within the spirit and scope of the present disclosure as defined by the claims.

### DETAILED DESCRIPTION

Complex or collective systems are collectives or ensembles of conservatively interacting entities. What one individual loses, others gain. This does not exclude the possibility of external interactions. Although, at the core, these systems are analytic, holomorphic, or complex, they also display simple emergent behaviors. Complex systems take many different forms. A plasma is a collective system of charged particles, a fluid is a collective system of molecules, a field is a collective system of elementary particles, a cosmos is a collective system of celestial bodies, a novel is a collective system of letters, a society is a collective system of individuals, and an economy is a collective system of economic entities (e.g., people, families, villages, countries, and companies) that engage in trade.

Provided are techniques for improved control and simulation of complex systems. Certain embodiments are based on a novel theory of collective behavior, comprising of characterization, forecast (e.g., simulation), and control (e.g., including stabilization, and optimal system and experimental design) of the complex system.

Provided in some embodiments are techniques for controlling a complex system including: obtaining an input of a functional of field and co-field functions; determining, based on the input functional and using a canonical functional transformation determined by a generating functional, an input function, the input function including a function of input basic state and co-state variables; determining, based on the input function and using a function transformation, the input basic state and co-state variables; determining, based on the input basic state and co-state variables and using a canonical transformation determined by a generating function that is a solution to a Hamilton-Jacobi equation, input fundamental state and co-state variables; determining, based on the input fundamental state and co-state variables and using a control function transformation, output fundamental state and co-state variables; determining, based on the output fundamental state and co-state variables and using an inverse canonical transformation determined by a generating function that is a solution to the Hamilton-Jacobi equation, output basic state and co-state variables; determining, based on the output basic state and co-state variables and using a function transformation, the output function, the output function including a function of output basic state and co-state variables; and determining, based on the output function and using an inverse canonical functional transformation determined by a generating functional, an output functional of the field and co-field functions, where a complex system operation is controlled based on the output functional of field and co-field functions.

In some embodiments, the canonical functional transformation determined by a generating functional includes: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection; the function transformations include: (1) a specified formula for a function; (2) a universal function approximator; or (3) a multi-layer perceptron (MLP) with rectified linear unit (ReLU) activation; the canonical transformation determined by a generating function that is a solution to a Hamilton-Jacobi equation includes: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder; the control function transformation includes: (1) a specified formula for a function; (2) a universal function approximator; (3) a multi-layer perceptron (MLP) with rectified linear unit (ReLU) activation; (4) a propagation function adapted to evolve the complex system; (5) a ponderomotive stabilization function adapted to stabilize unstable equilibriums of the complex system; (6) a feedback control function adapted to stabilize unstable equilibriums of the complex system; (7) a conservative force function adapted to optimize the performance, that is the design, of the complex system; or (8) a diffusive function adapted to cool, that is reduce the fluctuations, of the complex system; the inverse canonical transformation determined by a generating function that is a solution to the Hamilton-Jacobi equation includes: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder; and/or the inverse canonical functional transformation determined by a generating functional includes: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).

This description of systems and methods includes reference to physical collectives such as plasmas and fluids for the purpose of explanation. In particular, embodiments refer to examples concerning a fusion reactor, including, for example, control of plasma in the core of the fusion reactor. Although embodiments are described in certain context for the purpose of explanation, embodiments may be employed in any suitable context. For example, embodiments may be employed in the design and control of physical systems, such as automobiles, financial systems, or the like.

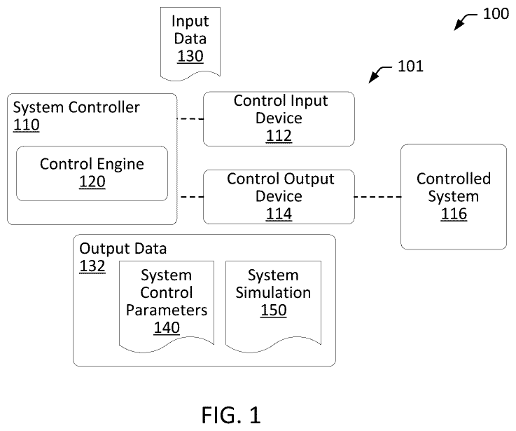

FIG. 1 is a diagram that illustrates a control environment (“environment”) 100 in accordance with one or more embodiments. Environment 100 includes a control system 101 that includes a system controller (“controller”) 110, one or more control input devices (“input device(s)”) 112, and one or more control output devices (“output device(s)”) 114, and a controlled system 116. Controller 110 includes a control engine 120 (e.g., a software module or the like) that may be operable to perform some or all of the operations of the controller 110 described here. In some embodiments, the controller 110 receives control input data (“input data”) 130 from one or more control input devices 112 and determines corresponding control output data (“output data”) 132 for use in controlling the controlled system 116. The output data 132 may include, for example, system control parameters 140 (e.g., initial operating parameters, updated operating parameters, or the like for controlling output device 114 or controlled system 116) or a system simulation 150 (e.g., a simulation predicting an operational outcome for the controlled system 116 based on use of a defined set of operating parameters, such as initial operating parameters, updated operating parameters, or the like).

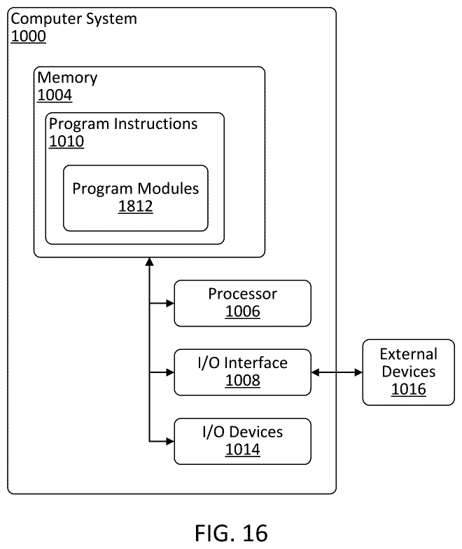

In some embodiments, the controller 110 receives input data 130 from an input device 112. The input data 130 may, for example, include fields, that are functions ƒ(x). The functions may, for example, be a field model that includes function of space and time, x. In some embodiments, controller 110 outputs output data 130 to an output device 114. The output data 132 may, for example include fields, that are functions ƒ(x). The functions may, for example, be a field model that includes function of space and time, x. This is in contrast to individual entities whose states are determined by scalars q. The state of a complex system, a collective of individual entities, is determined by functions ƒ(x), not scalars q. In some embodiments, controller 110 includes a computer system that is the same or similar to the computer system 1000 described with regard to FIG. 16.

In some embodiments, input devices 112 include devices operable to provide input data 130, such as observed measurements, simulations, or the like. Input devices 112 may include, for example, sensors that make measurements of the controlled system 116, computer systems that provide data for determining system control parameters 140, such as a simulator that provides simulations 150 of the controlled system 116, or the like. In some embodiments, an input device 112 includes a computer system that is the same or similar to the computer system 1000 described with regard to FIG. 16.

In some embodiments, output devices 114 include devices operable to employ output data 132, such as control parameters for controlling system 116. Output devices 114 may include, for example, actuators that apply a force to the controlled system 116 to set up the initial state of the controlled system 116, lasers that apply a force to the controlled system 116 as it evolves to stabilize the controlled system 116, antennas that radiate a EM field into the controlled system 116 to change the metastable equilibrium of the controlled system 116, a computer system that provides for execution of operations in accordance with output data 132, or the like. In some embodiments, an output device 114 includes a computer system that is the same or similar to the computer system 1000 described with regard to FIG. 16.

In some embodiments, the controlled system 116 includes a physical system. For example, the controlled system 116 may include a nuclear fusion reactor. In such an embodiment, input devices 112 may include sensors operable to measure various operational conditions of the nuclear fusion reactor and to provide corresponding input data 130 that includes, for example, the associated measurements, the controller 110 may be operable to determine corresponding output data 132 that includes system control parameters 140 (e.g., control parameters determined using the data processing techniques described here), such as settings for various operational systems within the nuclear fusion reactor. Such an embodiment may provide for initiating operation of the nuclear fusion reactor based on an set of initial system control parameters 140, continually monitoring associated measurements of collected input data 130 that is indicative of the operational state of the nuclear fusion reactor, determining updated sets of operational system control parameters 140 (e.g., a current set of control parameters determined using the data processing techniques described here) that are employed by output devices 114 to control or otherwise direct operations of the nuclear fusion reactor. Such a system may provide for operational startup and closed-loop control of the nuclear fusion reactor based on initial data and feedback that is indicative of the ongoing operational performance of the nuclear fusion reactor.

In some embodiments, system controller 110 generates a system simulation 150. Such a system simulation 150 may, for example, be used as a basis for design or control of a controlled system 116. For example, in the case of the nuclear fusion reactor, controller 110 may be operable to generate a system simulation 150 of operation of the nuclear fusion reactor based on a set of input data 130, such as historical measurements concerning operation of the nuclear fusion reactor or other nuclear fusion reactors. The system simulation 150 may include a set of initial system control parameters 140 and provide a prediction of operation of the nuclear fusion reactor employing those initial system control parameters 140. In such an embodiment, one or more simulations 150 may be generated and design and operation of the nuclear fusion reactor may be based on the one or more simulations 150. For example, where a given simulation 150 demonstrates a most desirable outcome for operation of the nuclear fusion reactor (e.g., a most effective outcome relative to other simulations and associated initial system control parameters 140), the system controller 110 may select the initial system control parameters 140 corresponding to the given simulation 150 and, in turn, control one or more output devices 114 to operate the controlled system 116 in accordance with the initial system control parameters 140 corresponding to the given simulation 150. For example, the system controller 110 may command actuators, valves, relays, and other reactor systems to operated (e.g., open, close, or the like) in a manner to maintain the nuclear fusion reactor at a working temperatures, pressures, and the like specified by the initial system control parameters 140. Continuing with the example described, the system controller 110 may, in turn, continue to monitor input data 130 for the nuclear fusion reactor, and provide updated sets of system control parameters 140 to maintain the nuclear fusion reactor in a suitable operational state. Thus, for example, the system controller 110 may employ techniques described here to develop, design, employ, monitor, and modify operational aspects of a controlled system. Although certain embodiments are described in the context of a nuclear fusion reactor for the purpose of explanation, embodiments may be employed with any suitable type of complex system to, for example, provide enhanced simulation, design, and control of complex system.

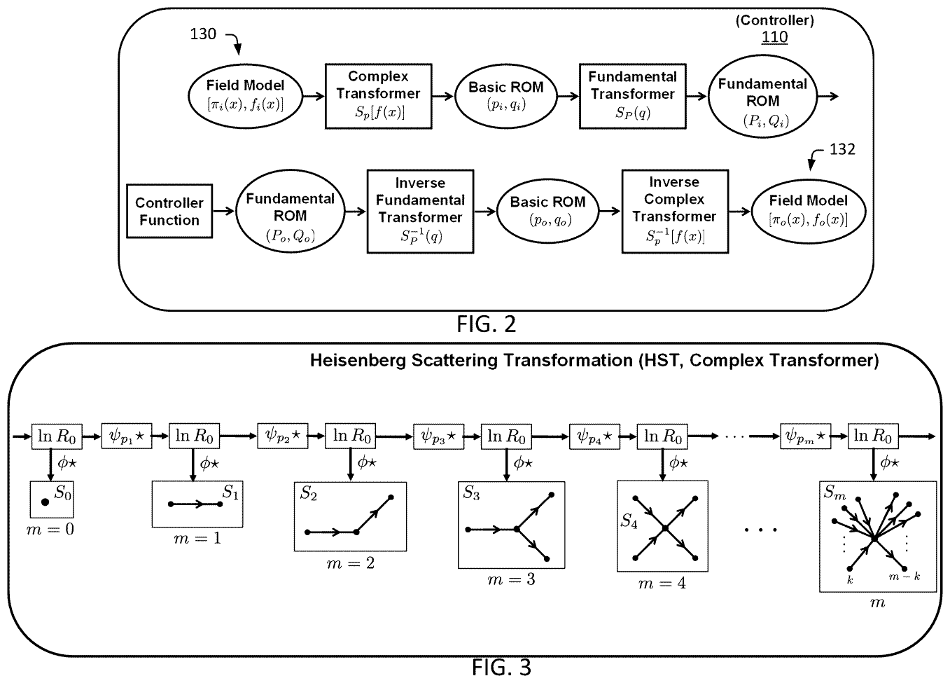

Referring again to example inputs and outputs including field models, in some embodiments, such as that shown in FIG. 2 (which is a diagram that illustrates operational aspects of a controller in accordance with one or more embodiments), the input data 130 input to the controller 110 is a field model, [πᵢ (x), βᵢ (x)] that is transformed by a complex transformer, specified by the generating functional of the canonical transformation Sₚ [ƒ(x)], into a basic ROM (reduced order model), (pᵢ, qᵢ). Next, the basic ROM is transformed to a fundamental ROM, (Pᵢ, Qᵢ) by a fundamental transformer, specified by the generating function of the canonical transformation S_{P} (q). The controller function may be a function that transforms the input fundamental ROM, (Pᵢ, Qᵢ), to a output fundamental ROM, (Pₒ, Qₒ). The output fundamental ROM may be transformed to the output basic ROM, (Pₒ, qₒ), by the inverse fundamental transformer, specified by the generating functional of a canonical transformation S_{P}⁻¹ (q). Finally, the output basic ROM may be transformed to an output field model, [πₒ (x), ƒₒ (x)], by an inverse complex transformer, specified to the generating functional of the canonical transformation S_{P}⁻¹ [ƒ(x)]. The described operations may, for example, be performed or otherwise employed by controller 110 (e.g., by way of execution of corresponding code by control engine 120). The output field model may, for example, be included in output data 132, and may be employed by one or more output devices 114 or an element of the controlled system 116 as described here.

In some embodiments, the generating functionals are approximated by deep convolutional neural networks (CNNs), which may employ one or more universal functional approximators. An approximator may be, for example, the Heisenberg scattering transformation (HST) followed by a principal components analysis (PCA) and a multi-layer perceptron (MLP) with rectified linear unit (ReLU) activation. In some instances, the HST includes a novel design for a complex transformer, such as that illustrated in FIG. 3 (which is a diagram that illustrates a complex transformer including the HST, an element of an example embodiment of the complex transformer, in accordance with one or more embodiments) and mathematically expressed as

$${H}_{m} [ f ( x ) ] ( z ) = {ϕ}_{px} ★ ( {\prod }_{k = 0}^{m} i ln {R}_{0} {ψ}_{{p}_{k}} ★ ) i ln {R}_{0} f ( x ) . \qquad ( 1 )$$

Such an embodiment may be a deep deconvolution with a specified canonical structure, a iln R₀ activation function, and a ϕ★ pooling operator. Details of the HST are discussed herein, at least in the Example Details of the HST Section.

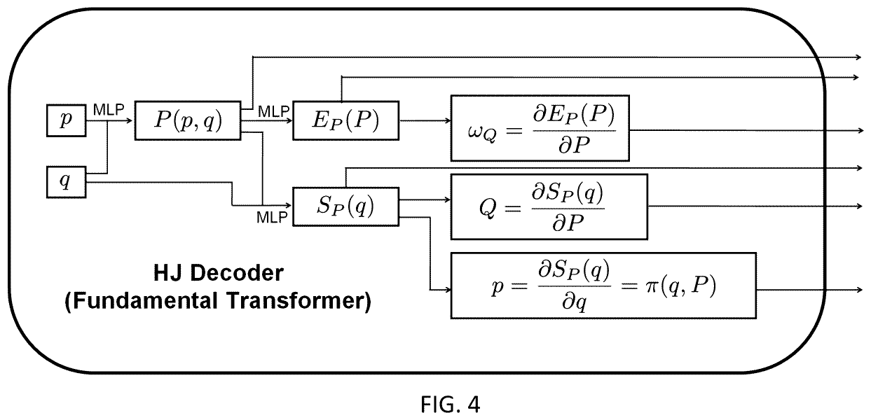

In some embodiments, the generating functions are approximated by MLPs w/ReLU, which are universal piece-wise linear function approximators. The approximator may be, for example, the Hamilton-Jacobi (HJ) decoder. In some instances, the HJ decoder is a novel neural network design for a fundamental transformer illustrated in FIG. 4. (which is a diagram that illustrates a fundamental transformer including the Hamilton-Jacobi (HJ) decoder in accordance with one or more embodiments). Such a design may embed the canonical structure of solutions to the Hamilton-Jacobi equation

$$\frac{\partial S ( P , E ; q , τ )}{\partial τ} + H ( \partial S / \partial q , q ) = 0 , \qquad ( 2 )$$

$$where S ( P , E ; q , τ ) ≡ {S}_{P} ( q ) - {E}_{P} τ . \qquad ( 3 )$$

Details of the HJ are discussed herein, at least in the Example Details of the HJ Decoder Section.

### Example Details of the HJ Decoder

A fundamental mathematical problem is the constrained optimization of a value functional

$$V [ q ( τ ) ] = \int R ( q ( τ ) ) d τ , \qquad ( 4 )$$

where R (q) is the reward or potential energy given the state q of the system, and τ is the evolution parameter, commonly time. The optimization is constrained by a force equation

$$\frac{dq}{d τ} = f ( q , dq / d τ ) = f ( q , \dot{q} ) . \qquad ( 5 )$$

This problem may be approached using the method of Lagrange multipliers by forming the Lagrangian

$$L ( q , \dot{q} , p ) = p ( \dot{q} - f ( q , \dot{q} ) ) - R ( q ) \qquad ( 6 )$$

where p is the Lagrange multiplier or co-state of the system or action. The Lagrangian can be re-written as

$$L ( q , \dot{q} ) = {L}_{0} ( q , \dot{q} ) - R ( q ) \qquad ( 7 )$$

where p=∂L₀/∂\dot{q}=g (q, \dot{q}) so that

$${L}_{0} ( q , \dot{q} ) = g ( q , \dot{q} ) [ \dot{q} - f ( g ( q , \dot{q} ) , q ) ] . \qquad ( 8 )$$

The next step can include forming the value functional

$$V ( q , τ ) = V [ q ( τ ) ] = \int L ( q ( τ ) , \dot{q} ( τ ) ) d τ \qquad ( 9 )$$

and using the calculus of variations to set δV=0 giving Lagrange's equation of motion

$$\frac{d}{d τ} ( \frac{\partial L}{\partial \dot{q}} ) - \frac{\partial L}{\partial q} = 0. \qquad ( 10 )$$

The system can also be analyzed from the Hamiltonian perspective by making the Legendre transformation

$$H ( p , q ) = p \dot{q} - L ( q , \dot{q} ) = pf ( p , q ) + R ( q ) \qquad ( 11 )$$

where \dot{q}=g⁻¹ (p,q)=ƒ̅(p,q) and ƒ(p,q)=ƒ(q,ƒ̅(p,q)). In such an embodiment, the equations of motion are now Hamilton's equations of motion

$$\frac{dp}{d τ} = \frac{\partial H}{\partial q} and \qquad ( 12 )$$

$$\frac{dp}{d τ} = - \frac{\partial H}{\partial q} . \qquad ( 13 )$$

If the motion is deterministic, the method of characteristics can be used, in what is commonly referred to as Pontryagins Maximum Principal of Control Systems.

In some embodiments, a canonical transformational approach is employed and results in the Hamilton-Jacobi (HJ) equation. This method may not rely on the method of characteristics so that it can be applied to systems that are not integrable, that is stochastic. This approach may find a canonical transformation generated by the value functional so that the transformed Hamiltonian is zero, giving transformed coordinates that are constants in t. In such embodiments, a resulting equation is

$$\frac{\partial V ( q , P , τ )}{\partial τ} + H ( \partial V / \partial q , q ) = 0 \qquad ( 14 )$$

or the non-conservative Hamilton-Jacobi-Bellman form which adds resistivity, v, to stabilize the solution

$$\frac{\partial V ( q , P , τ )}{\partial τ} + \frac{\partial V}{\partial q} f ( \partial V / \partial q , q ) + R ( q ) = v V , \qquad ( 15 )$$

giving

$$p = \frac{\partial V}{\partial q} and \qquad ( 16 )$$

$$Q = \frac{\partial V}{\partial P} . \qquad ( 17 )$$

The value functional V (q, P, τ) is referred to Hamilton's Principal Function and can be written as

$$V ( q , P , τ ) = \int pdq - H d τ . \qquad ( 18 )$$

Because the Hamiltonian H (p,q) is not τ dependent, the value functional can be written as

$$V ( q , P , τ ) = W ( q , P ) - E ( P ) τ \qquad ( 19 )$$

where W (q,P) is referred to as Hamilton's Characteristic Function and can be written as

$$W ( q , P ) = \int pdq , \qquad ( 20 )$$

$$where p = \frac{\partial W ( q , P )}{\partial q} ≡ π ( q , P ) , \qquad ( 21 )$$

$$Q = \frac{\partial W ( q , P )}{\partial P} and \qquad ( 22 )$$

$${ω}_{Q} ( P ) ≡ \frac{\partial E ( P )}{\partial P} . \qquad ( 23 )$$

The equations of motion for the transformed coordinates are

$$\frac{dP}{d τ} = 0 and \qquad ( 24 )$$

$$\frac{dQ}{d τ} = \frac{\partial E ( P )}{\partial P} = {ω}_{Q} \qquad ( 25 )$$

with solution

$$P ( τ ) = {P}_{0} and \qquad ( 26 )$$

$$Q ( τ ) = {ω}_{Q} τ + {Q}_{0} . \qquad ( 27 )$$

To add external forces, (e.g., non-conservative forces (that may be globally conservative)), one may analytically continue the Hamiltonian and make the canonical transformation q̅=(q+ip)/\sqrt{2} and p=(p+iq)/\sqrt{2}. In such an embodiment, the complex analytic Hamiltonian H(β) is now given by

$$H ( β ) = H ( \overline{p} , \overline{q} ) = {H}_{Re} ( \overline{p} ) + i {H}_{Im} ( \overline{q} ) \qquad ( 28 )$$

so that there are two orthogonal sets of motion, one for H_{Re} (conservative motion generated by H=H_{Re}=E and parameterized by group parameter τ) with equations of motion

$$\frac{dq}{d τ} = \frac{\partial {H}_{Re}}{\partial p} and \qquad ( 29 )$$

$$\frac{dp}{d τ} = - \frac{\partial {H}_{Re}}{\partial q} , \qquad ( 30 )$$

and one for H_{Im} (non-conservative motion generated by Ad (H)=iH_{Im}=iωτ=iθ and parameterized by group parameter iE/ω=iJ) with equations of motion

$$\frac{dq}{dJ} = i \frac{\partial ( i {H}_{Im} )}{\partial p} = - \frac{\partial {H}_{Im}}{\partial p} and \qquad ( 31 )$$

$$\frac{dp}{dJ} = - i \frac{\partial ( i {H}_{Im} )}{\partial q} = \frac{\partial {H}_{Im}}{\partial q} , \qquad ( 32 )$$

$$where Δ J = J - {J}_{0} = {\int }_{0}^{τ} \frac{1}{\dot{q}} \frac{\partial H}{\partial τ} d τ = \int {F}_{ext} d τ , \qquad ( 33 )$$

so that

$$dE = \frac{\partial H}{\partial τ} d τ = \dot{q} dJ = \dot{q} {F}_{ext} d τ = {F}_{ext} dq . \qquad ( 34 )$$

When the Hamilton-Jacobi equation given in Eq. (14) is solved in this analytically continued extended phase space, the transformed analytic Hamiltonian is given by

$$\begin{matrix}H ( β ) = H ( P , Q ) = {E}_{P} ( P ) + i \frac{\partial W ( q ( P , Q ) , ) P}{\partial J} \\ = {E}_{P} + i \frac{\partial W}{\partial P} \frac{\partial P}{\partial {J}_{P}} \\ = {E}_{P} ( P ) + i Q \\ = {E}_{P} ( P ) + i {0}_{Q} ( Q ) \\ = {H}_{Re} ( P ) + i {H}_{Im} ( Q )\end{matrix} \qquad ( 35 )$$

$$or H ( p , q ) = {E}_{P} ( P ( q , p ) ) + i \frac{\partial W ( q , P ( p , q ) )}{\partial J} , where \qquad ( 36 )$$

$${θ}_{Q} ( Q ) = ω τ = Q and \qquad ( 37 )$$

$${J}_{P} ( P ) = E / ω = P . \qquad ( 38 )$$

The equations of motion for the conservative motion with group parameter τ are

$$\frac{dQ}{d τ} = \frac{\partial {E}_{P} ( P )}{\partial P} ≡ {ω}_{Q} and \qquad ( 39 )$$

$$\frac{dP}{d τ} = 0 , \qquad ( 40 )$$

and the equations of motion for the non-conservative motion with group parameter ij are

$$\frac{dQ}{dJ} = 0 and \qquad ( 41 )$$

$$\frac{dP}{dJ} = 1 , \qquad ( 42 )$$

with differential solution

$$dQ = {ω}_{Q} d τ and \qquad ( 43 )$$

$$dP = \frac{dE}{{ω}_{Q}} = {ω}_{P} dE = {F}_{ext} d τ , \qquad ( 44 )$$

where ω_{P}=1/ω_{Q}. The finite solution is

$$Δ Q = Q - {Q}_{0} = {\int }_{0}^{τ} {ω}_{Q} d τ and \qquad ( 45 )$$

$$\begin{matrix}Δ P = P - {P}_{0} \\ = {\int }_{0}^{τ} {ω}_{P} \frac{\partial H}{\partial τ} d τ = {\int }_{0}^{Δ E} \frac{dE}{{ω}_{Q}} \\ = {\int }_{0}^{τ} {F}_{ext} d τ ,\end{matrix} \qquad ( 46 )$$

$$where dE = {ω}_{Q} dJ = {ω}_{Q} {F}_{ext} d τ = {F}_{ext} dq . \qquad ( 47 )$$

It it noted that after a significant amount of time has elapsed (ω_{Q}τ>>1), uncertainty in the value in ω_{Q} will cause the motion to become stochastic. Not only will the value of Q not be known, even the number of cycles of temporal period τ₀=2π/ω_{Q} will not be known. In such an embodiment, the value of Q will simply be uniformly distributed from 0 to 2π.

The form of the imaginary part of the Hamiltonian in Eq. (36)

$${H}_{Im} ( p , q ) = \frac{\partial W ( q , P ( p , q ) )}{\partial J} \qquad ( 48 )$$

can be helpful. This is the partial derivative of the action
S_{Ad(H)}=∫τdE=∫θ_{Q}dJ_{P}=∫p dq=W (q, p; P) of the Ad (H) group with generating function Ad (H)=iH_{Im}=iωτ=iθ_{Q}=i∂W/∂J and associated group parameter iJ=iE/ω.

Given development of this approach, one may employ it in a practical application, such as controlling a system. Such an application may employ artificial intelligence (AI) as methods of function and functional approximation. This may include, first, constructing a dataset by doing an ensemble of simulations of the system or by observing the system. It can be assumed that the system has a small number of dimensions. Generally, most of the systems of interest are fields ƒ(x) that are elements of a Hilbert space not q(τ) with a small number of components. Details of how to reduce the field from a Hilbert space to [symbol] ⁿ using the Heisenberg scattering transformation (HST) and a principal components analysis (PCA) is discussed at least in the Example Details of the HST Section. It can be helpful to apply an external force Fₑₓₜ (p, q) to the system being simulated or observed to sample phase space more efficiently. This may include use of a dissipation or a random diffusion which samples phase space well, as the system gradually relaxes to the stable equilibriums. It can also be helpful to apply an external force that is constructed to keep the dynamic trajectory in the vicinity of the unstable local maximums, that is stabilizes the unstable equilibriums. In such embodiments, the set of variables recorded include τ, in addition to variables that are related to the state q(τ) and the co-state p(τ).

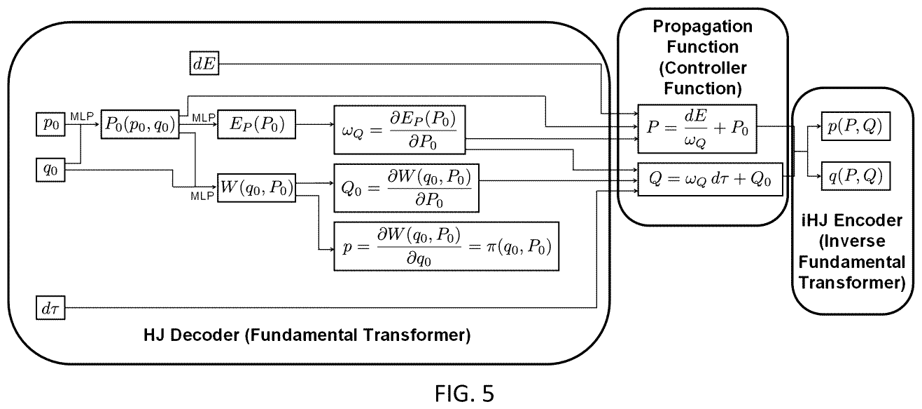

In some embodiments, given the dataset, training a neural network with an architecture that matches the structure of the solution to the HJ equation is performed to estimate: (1) the decoding of the p and q coordinates into the P (p, q) and Q (p, q) coordinates that are the solution to the HJ equation as well as the encoding of P and Q to p (P, Q) and q (P, Q), (2) the value function W (q, P) that generates these canonical transformations and is related to the imaginary part of the analytic Hamiltonian as shown in Eq. (48), (3) the mapping of P to the real part of the analytic Hamiltonian εₚ (P), (4) the frequency ω_{Q} (P), (5) the policy π(q, P) and (6) the analytic advance of P and Q given in Eqns. (44) and (43). Multi-layer perceptrons (MLPs) may be used to approximate some of the functions. The derivative functions may be calculated by back propagating the MLPs. An example of such an architecture is shown in FIG. 5. (which is a diagram that illustrates a neural network architecture in accordance with one or more embodiments). The rectified linear units (ReLUs) may be used as activation functions in the MLPs because the MLPs are approximating analytic functions which are maximally flat but do have a limited number of singularities where the derivative is discontinuous. MLPs with ReLUs may be especially useful for doing this since they are universal piece-wise linear approximators with discontinuities in the derivative.

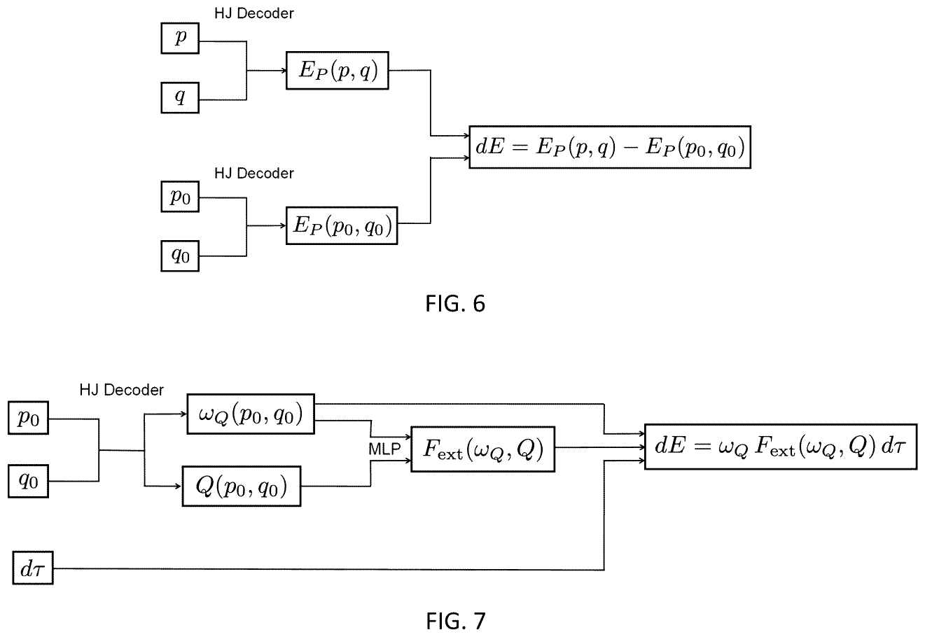

In some embodiments, the training step includes useful details. Although one has the inputs (p₀, q₀, dτ) and outputs (p, q), it is desirable to know dE. For a conservative system with no external force being applied dE=0, but that is not the case with this dataset. A solution is to use the fundamental Transformer E_{P} (p, q) to estimate dE=E_{P}(p,q)−E_{P}(p₀, q₀), using the target outputs as an input to estimate E_{P} (p, q), as shown in FIG. 6. (which is a diagram that illustrates an addition to a neural network architecture to estimate a change in energy value (dE) in accordance with one or more embodiments). If, for example, this workflow is being used to train a surrogate where the external force is part of the dynamics that is being modeled, a model for the external force Fₑₓₜ (ω_{Q}, Q) may be estimated using an MLP so that dE=ω_{Q} Fₑₓₜ (ω_{Q}, Q)dτ, as shown in FIG. 7 (which is a diagram that illustrates an addition to a neural network architecture to estimate external force in accordance with one or more embodiments). If the force is resistive, diffusive friction Fₑₓₜ=−Σ_{P}ω_{Q}, where ε_{P}<<J₀. In this case, Rayleigh's Dissipation Function can be defined

$$≡ \frac{{ε}_{P}}{2} {ω}_{Q}^{2} \qquad ( 49 )$$

$$so that \frac{dE}{d τ} = - {ε}_{P} {ω}_{Q}^{2} = - 2 . \qquad ( 50 )$$

The estimation of Fₑₓₜ (ω_{Q}, Q) may be viewed as an estimation of Rayleigh's Dissipation Function where

$$( {ω}_{Q} , Q ) = - \frac{{ω}_{Q}}{2} {F}_{ext} ( {ω}_{Q} , Q ) . \qquad ( 51 )$$

The solution of the system dynamics has the conservative force F₀ (q)=−∇R₀ (q) of the uncontrolled system, where R₀ (q) is the reward optimized by the uncontrolled system. The dynamics can be modified to optimize a desired reward R(q). In some embodiments, this includes calculating the conservative control force F_{c} (q) (that is the incremental action, Δp/Δτ) that may need to be applied to change the reward that is optimized. Estimate F₀ (q), then calculate the control force

$${F}_{c} ( q ) ≡ F ( q ) - {F}_{0} ( q ) = Δ ( dp / d τ ) , \qquad ( 52 )$$

where F(q)=−∇R(q) and

$${F}_{0} ( q ) = \frac{\partial {E}_{P} ( p = 0 , q )}{\partial q} \qquad ( 53 )$$

which is found by back propagating the derivatives in the MLP. Here, the system may be simulated or observed again, this time applying the control force, but not including that control force in the calculation of ΔE. The neural network may be fit again, with this new dataset.

One now has a solution of the HJ equation that has estimated the analytic Hamiltonian H(β). A next step may be finding the equilibriums β* or P* where

$$\frac{\partial {E}_{P} ( {P}^{*} )}{\partial P} = 0 . \qquad ( 54 )$$

Given the function E_{P} (P) estimated in the workflow shown in FIG. 5, P* can be found with a high performance root finder, both stable and unstable equilibriums. The equilibrium policy can then be estimated as π*(q)=π(q, P*) and the equilibrium value as V*(q)=W (q, P*). One now has estimated the B* which are viewed different ways by different technical disciplines. These may be, for example, the following: (1) the ground states of quantum field theory, (2) the attractive manifolds of nonlinear dynamics, (3) the emergent behaviours and self organizations of complex systems, (4) the Taylor relaxed states and BGK modes of plasma physics, (5) the poles and branch cuts of control theory and complex analysis, and fundamentally (6) the homology classes of the topology of the dynamic manifold or the geometry of the physics. The equilibrium values β* need not be points. These may, for example, be algebraic structures, if n>1.

In such embodiments, knowing β* is equivalent to knowing the analytic function H(β), where H(β) is the solution of Laplace's equation given the boundary β*. The motion on the dynamical manifold is simply geodesic motion with the complex curvature, or S-matrix, given by

$${S}_{m} = \frac{{d}^{m} H ( β )}{d {β}^{m}} . \qquad ( 55 )$$

The analytic function H(β) specifies the geodesics Re (H(β))=E of the motion generated by H=H_{Re}=E_{P} with group parameter τ, and the geodesics of the adjoint motion Im (H(β))=ωτ=θ generated by Ad(H)=iH_{Im}=iθ_{Q} with group parameter iJ=iE/ω. The complete motion may be generated by the Weyl-Heisenberg group [symbol] = [symbol] ⊗Ad( [symbol] ) on extended phase space with Lagrangian or Poincaré one form λ=pdq-Hdτ=τdE−Edτ=θdJ−Edτ, symplectic metric or Poincaré two form dλ=dp∧dq−dH∧dτ=2dτ∧dE, complex group parameter τ+iJ, complex analytic Hamiltonian or complex group generating function H(β)=E_{P}+iθ_{Q}, and group action S=∫λ=S_{Ad(H)}−S_{H}=W−∫Edτ, where W=∫θdJ and θ=∂W/∂J—a complex Lie Group. Note that, in such an embodiment, the complex finite group propagator is

$$\begin{matrix}U ( τ + iE / ω ) = {U}_{Ad ( H )} ( E ) {U}_{H} ( τ ) = {e}^{iS} \\ = {e}^{{iS}_{Ad ( H )}} {e}^{- {iS}_{H}} = {e}^{i \int τ dE} {e}^{- i \int Ed τ} \\ = {e}^{i W} {e}^{- i \int Ed τ} \\ = {e}^{i W} {e}^{- iE τ} , if \frac{\partial E}{\partial τ} = 0.\end{matrix} \qquad ( 56 )$$

Therefore, if the motion is conservative, the propagators are

$${U}_{Ad ( H )} ( E ) = {e}^{iW} , and \qquad ( 57 )$$

$${U}_{H} ( τ ) = {e}^{- iH τ} , \qquad ( 58 )$$

the later being the field theory expression for the propagator. If the motion is not conservative,

$${U}_{Ad ( H )} ( E ) = {e}^{iW} = {e}^{{iW}_{P ( E )}} \qquad ( 59 )$$

is unchanged and

$${U}_{H} ( τ ) = {e}^{- i \int E ( τ ) d τ} = {e}^{- i \int H ( p ( τ ) , q ( τ ) ) d τ} . \qquad ( 60 )$$

A distinction to make is that E(τ) is changing with τ, not the forms of H(p, q) and W_{P} (p,q). Even if the motion is not conservative, it is still constrained to the manifold [symbol] = [symbol] ⊗Ad( [symbol] ) with the algebra of H(β) on [symbol] ⁿ.

If can be helpful to recognize that at the equilibrium points P* the external forces can not change the system's energy because ω_{Q} (P*)=0 and dE/dτ=ω_{Q} (P*) Fₑₓₜ=0 for all Fₑₓₜ.

Keeping the above in mind, one can progress to solving the general problem of control. First, one can change the reward or potential energy function from R₀ (q) to R (q) using F_{c} (q) of Eq. (52). This may include identifying R₀ (q). In some embodiments, this is done by learning the solution to the HJ equation E_{P} (P) and W(q, P)=W_{P} (p,q), that is the energy and the canonical generating function. The solution can be harvested for R₀ (q), and for β*.

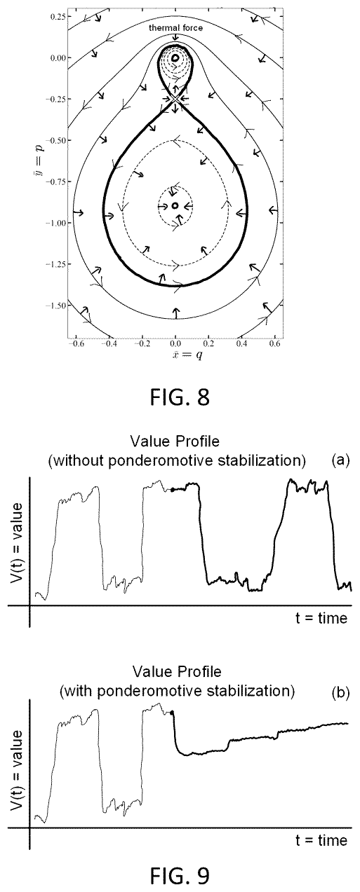

In some embodiments, the system as a nonlinear dynamical system, and the control problem is a problem in nonlinear systems control. One can start this discussion by referring to FIG. 8, which is a diagram that illustrates a representative contour plot for a physical system in accordance with one or more embodiments. It also can be looked at as a topography map. In the illustrated embodiment, this map has two basins with basin centers indicated by the o-points, and one saddle point (mountain pass) between the basins indicated by the x-point. There are strong non-conservative thermal forces that will take a conservative system to the o-point once in the respective basin. They are also stable equilibriums. This is in contrast to the x-point, which is the point that the system descends from the mountain, but it is not a stable equilibrium so that as it is approached the system will fall into one of the basins. The discipline of nonlinear dynamics often refers to these x-points as semi-attractors. Semi-attractors first attract the trajectory to them, but once reached repel the trajectory away from them. These unstable equilibriums are the desirable states from a long term value perspective. They may benefit from an active control system, though, in order to stabilize them. This may be like stabilizing an inverted pendulum with a vibrating saw. In such embodiments, the controller needs to vibrate the system in order to stabilize the system. A technical problem is identifying the natural frequencies of the system. For instance, when one flies a plane, one must take into account that it takes several seconds for the plane to respond. If one tries to make corrections faster than this, one will over-correct and cause the plane to go out of control. The issue with complex systems is that they have many natural frequencies. Certain control systems only have a single time scale, and can have catastrophic phase lags built in that destabilize the system.

In some embodiments, the stabilization and cooling of the saddle points can be done directly via a feedback force

$${F}_{sf} ( P ) = - {ω}_{sf} ( P - {P}^{*} ) - {ε}_{P} {ω}_{Q} ( P ) = Δ ( dP / d τ ) , \qquad ( 61 )$$

where ω_{sf}≳ω₀ and ε_{P}<<J₀, and ω₀ is the dominate spectral frequency or the ground state frequency ω₀=E₀/J₀. This can be difficult to do because both P (which is oscillating rapidly about P*) and P* must be known or measured. It can be advantageous to apply the ponderomotive equivalent and random walk equivalent

$${F}_{sp} ( τ ) = {f}_{0} {e}^{i {ω}_{sp} τ} + {ω}_{0} {ε}_{P} = Δ ( dP / d τ ) , \qquad ( 62 )$$

where ω₀<<ωₛₚ, J₀ω₀≲∫₀<<J₀ωₛₚ (so that the ponderomotive force is large but the motion is small) and ε_{P} is a random ΔP of size ε_{P}<<J₀ taken every 2π/ω₀. This Fₛₚ (τ) force is not dependant on P* or P, just the time invariant mapping generated by W (q, P) of p (P, Q) and q (P, Q), and the functional transformation iPCA+iHST of ƒ[p(τ), q(τ)](x) and π[p(τ), q(τ)](x) or ∫[p+iq](x)+iπ[q+ip](x) as will be discussed in the Example Details of the HST Section. The result of applying the ponderomotive stabilization force is shown in FIG. 9, which is a diagram that illustrates value profiles (with and without the ponderomotive stabilizer) in accordance with one or more embodiments.

In some embodiments, the stabilizing and cooling force is constructed to “fine” any malicious attempt to excite the complex system for exploitative gain such as a “pump and dump” technique in financial systems, such as the stock market. Since the controller knows π*(q), it will sell high as the malicious entity is pumping and will buy low as the malicious entity is dumping.

Another way of looking at this is that the controller has modified the dynamics to make the equilibrium a ground state. An external system can only excite the conservative system, putting energy into the system. The controller then de-excites the system back into the ground state, taking energy out of the system. The net result is a flow of energy from the external system to the controller—a “heat pump” of energy from the external system to the controller.

A problem with certain attempts to control complex systems is not knowing what reward R₀ (q) the system is naturally optimizing, and not knowing the equilibrium point P* of the system optimizing R (q) (equivalently the equilibrium value V* (q) or the equilibrium policy π*(q)). Knowing both F₀ (q) and π*(q) may be essential to controlling the system to optimize R(q) and to be stable with minimum fluctuations about the equilibrium where the objective V(q,P, τ) is optimized. The conservative force to be applied is F_{c} (q) and the stabilizing and cooling force is F_{sf} (P). A simple way to state this is that the controller may need to know what to control about. In this case, it is F₀ (q) and π*(q) or P*. For the ponderomotive control with Fₛₚ (τ), current attempts at control do not know the canonical transformation generated by W (q, P) or the characteristic spectrums |βᵢ (z) [symbol] that may need to be applied to the fields, as will be discussed in the Example Details of the HST Section.

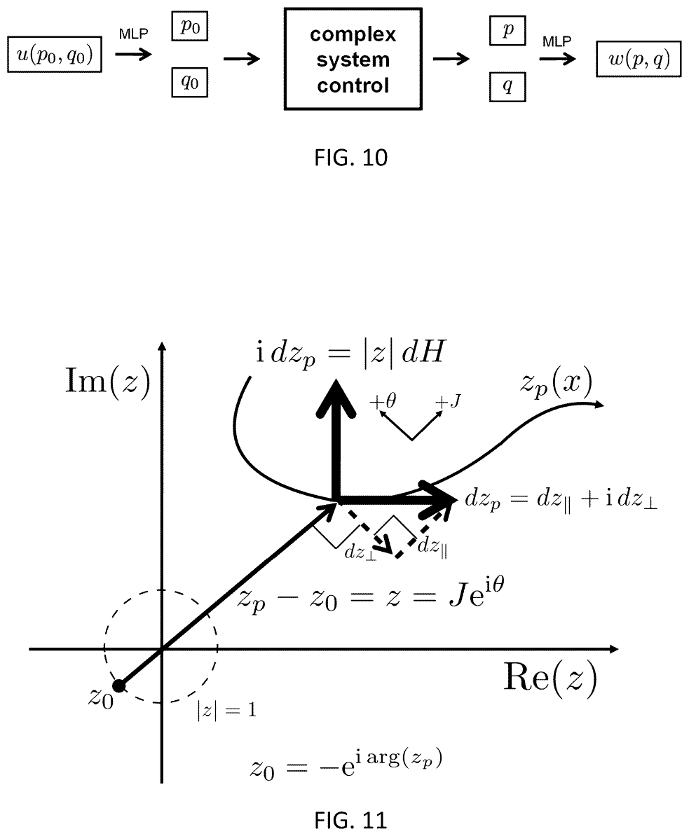

The inputs (which includes controls) and outputs of the control system may not be q and p, but functions u(p, q) for inputs and functions w(p,q) for outputs. A straight forward addition can be made to the workflow as shown in FIG. 10 (which is a diagram that illustrates input and output variables of a control system workflow in accordance with one or more embodiments). An MLP that approximates the functions p(u) and q(u) may be added before the control system, and another MLP that approximates w(p, q) may be added after the control system.

### Example Details of the HST

An HST may be viewed different ways. It can, for example, be viewed as the S-matrix, the Mayer Cluster Expansion, the m-body scattering cross sections, and the m-body Green's functions. The HST functional transformation may be the Wigner-Weyl transformation. The HST may take the dynamics to a manifold that is, for example, a linear subspace of a Hilbert space with basis vectors that are the solution to the Renormalization Group Equations (RGEs). In this subspace, the dynamics may be geodesic motion with the topology given by the Hamiltonian function H(z), an analytic function on [symbol] ⁿ, where n is the number of fields. Another way of looking at this is that the motion is harmonic or holomorphic. In some embodiments, a process starts by constructing a logarithmic generator of the function H̅≡iH. First, Taylor expand the function H̅ about z₀ giving

$$\overline{H} ( z ) = {\sum }_{n = 0}^{∞} \frac{1}{n !} {S}_{m} ( {z}_{0} ) {( z - {z}_{0} )}^{n} , \qquad ( 63 )$$

$$where {S}_{m} ( z ) = \frac{{d}^{m} \overline{H} ( z )}{{dz}^{m}} = \frac{{dH}_{m}}{dz} . \qquad ( 64 )$$

which serves as a definition of Hₘ (z). Now we need to find an expression for Hₘ given Hₘ₋₁. Start by assuming that Hₘ is a functional of the field and the field momentum, that is

$${H}_{m} ( z ( x ) ) = F [ π ( x ) , f ( x ) ] . \qquad ( 65 )$$

Define the wavelet transformation

$${ψ}_{p} ★ f ( x ) = \int {ψ}_{p} ( {x}^{′} ) f ( x - {x}^{′} ) {dx}^{′} , \qquad ( 66 )$$

where ψₚ (x) are a normalized, orthogonal, localized and harmonic (that is coherent states) such that

$${ψ}_{p} ( x ) ≡ {p}^{2} ψ ( px ) , and \qquad ( 67 )$$

$${ϕ}_{px} ( {x}^{′} ) ≡ {p}^{2} ϕ ( p ( {x}^{′} - x ) ) , \qquad ( 68 )$$

where ψ(x) and ϕ(x) are the Mother and Father wavelets that satisfy the Littlewood-Pauley condition. Consider

$${z}_{p} ( x ) ≡ {ψ}_{p} ★ {H}_{m - 1} ( z ( x ) ) . \qquad ( 69 )$$

It may be proven, using the fact that π(x), the conjugate field momentum, and ƒ(x) satisfy the field equations (Hamilton's equations, that is a diffeomorphism on a cotangent bundle T*Mⁿ), ψₚ (x) are coherent states, and the functional chain rule; that zₚ(x) is a trajectory on the complex plane that satisfies the Cauchy-Riemann conditions. That is to say, zₚ(x) is an analytic trajectory. Here, it can be helpful to calculate the analytic function that gives this trajectory. See, for example, FIG. 11 (which is a diagram that illustrates a mathematical foundation a complex transformer of the canonical structure of the HST transformer in accordance with one or more embodiments) for a graphical representation of this derivation. Take the covector dzₚ along this trajectory, change to radial coordinates about z₀=−e^{i arg (z}^{ₚ}⁾ such that z=zₚ−z₀=Je^{iθ}, and rotate by π/2 (that is multiply by i), to get these expressions for the covector

$$\begin{matrix}{dH}_{m} ( z ) = i \frac{d {z}_{p}}{\vert z \vert} = i ( \frac{{dz}_{∥}}{\vert z \vert} + i \frac{{dz}_{⊥}}{\vert z \vert} ) \\ = i ( \frac{dJ}{J} + i θ ) = i d ( ln ( J {e}^{i θ} ) ) \\ = i d ( ln z ) = d ( i ln z ) .\end{matrix} \qquad ( 70 )$$

### Defining

$${R}_{0} ( z ) ≡ z + {e}^{i arg ( z )} , \qquad ( 71 )$$

one gets

$$\begin{matrix}{H}_{m} = i ln z = i ln ( {R}_{0} ( {z}_{p} ) ) \\ = i ln {R}_{0} {ψ}_{{p}_{m}} ★ {H}_{m - 1} .\end{matrix} \qquad ( 72 )$$

With the complex logarithm

$$ln ( z ) = ln \vert z \vert + i arg ( z ) , \qquad ( 73 )$$

and with the definition of R₀ given in Eq. (71),

$$ln ( {R}_{0} ( z ) ) {\to }_{\vert z \vert \to 0} z \qquad ( 74 )$$

is a compact mapping. We can use ƒ(x) as shorthand for any F[π(x), ƒ(x)]. Start with

$${H}_{0} = i ln {R}_{0} f ( x ) . \qquad ( 75 )$$

Remove the explicit x dependence with a convolution with a final convolution with ϕₚₓ. Choose normally ordered paths so that

$${p}_{k + 1} 〈 {p}_{k} and {x}_{k + 1} 〉 {x}_{k} , \qquad ( 76 )$$

so that we can define

$$p = {\sum }_{k = 1}^{m} {p}_{k} and x = {\sum }_{k = 1}^{m} {x}_{k} . \qquad ( 77 )$$

This yields the following expression for the iterative logarithmic generating functional (the HST)

$${H}_{m} [ f ( x ) ] ( z ) = {ϕ}_{p x} ★ ( {\prod }_{k = 0}^{m} i ln {R}_{0} {ψ}_{{p}_{k}} ★ ) i ln {R}_{0} f ( x ) , \qquad ( 78 )$$

where z≡p+ix. This logarithmic generating functional (LG) generates, by construction, iH (z)=H̅(z). This may not involve the exponential generator, propagator, or partition function, given by U=e^{-iHτ} or Z=e^{iS}, as is done, for example, in the Lagrangian approach. It follows that

$${LG}^{″} ( z ) = 0 , \qquad ( 79 )$$

which means that the transformation has flattened the space so that the infinitesimal generator, iH, is now the finite group generator. We have transformed to the basis |β(p,x) [symbol] , the Hilbert space of all possible solutions to the RGEs, corresponding to Sₘ=dHₘ/dz, the S-matrix. The basis vectors |βᵢ (z) [symbol] can be approximated by a PCA. The motion can be confined to an n-dimensional complex linear hyperplane and will be geodesic motion on that submanifold, determined by the analytic function H(β), with curvature dH/dβ=1/β=S. Streamlines of the motion generated by H (the [symbol] group action) are given by Re(H(β))=constant, and streamlines of dH (the Ad( [symbol] ) group action) are given by Im(H(β))=constant.

Referring again to the HST, in such embodiments, the ψₚ★ is generating zₚ (x) a parametric trajectory of the analytic function iH. The ln R₀ conformal (canonical) transformation is flattening the space onto the cylinder by transforming into polar coordinates about R₀. The i conformal transformation is rotating π/2 from the tangent direction to the gradient (covector) direction. Another perspective views it as a canonical transformation that is exchanging the field momentum with the field. Use of R₀ may ensure that the repeated application of the mapping converges to a circle of radius π about the origin on the cylinder. This is because R₀ is a fixed point of ln, that is ln(R₀ (z)→z as |z|→0. In such an embodiment, the convergence to the origin is exponential for large deviations, then logarithmic for small deviations.

It should be noted that the transformation may no longer be stationary since the Father Wavelet only averages over as large of a patch as it has to do. However, this partition of unity may be summed over a larger domain in x, if, for example, the process is stationary over that domain. Such a transformation may be complex from the beginning to the end.

The process of one iteration of the HST may involve the following: the convolution generates an analytic trajectory on the complex plane, and the In changes to polar coordinates after translating the origin to the fixed point of the mapping, all canonical and analytic transformations. This flattens the space, and exposes the curvature of the manifold as the expansion coefficients, dH/dβ. Such a process may involve taking the canonical derivative, id(ln), where the exterior derivative is taken by ψ★.

This Mayer cluster expansion, in the order of the correlation m, is super convergent of order e^{n!} or greater. Write the expansion as

$${S}_{p} [ f ( x ) ] = {\sum }_{m = 0}^{∞} {S}_{m} , \qquad ( 80 )$$

where Sₘ ≳(e^{n!}). Embodiments may not include expanding in the weakness of correlation (e.g., the BBGKY hierarchy of plasma physics), or the strength of the coupling constant (e.g., the perturbation expansion of field theory). Each term of the Mayer cluster expansion may be expanded in the correlation parameter of coupling constant, Γ,

$${S}_{m} = {\sum }_{n = 0}^{∞} {a}_{m n} {Γ}^{n} , \qquad ( 81 )$$

then the terms of like order in Γ are collected

$${A}_{n} = {\sum }_{m = 0}^{∞} {a}_{m n} , \qquad ( 82 )$$

so that

$${S}_{p} [ f ( x ) ] = {\sum }_{n = 0}^{∞} {A}_{n} {Γ}^{n} . \qquad ( 83 )$$

A problem is that the convergence in Aₙ is only asymptotic, so that

$${A}_{n} {\to }_{n \to ∞} ∞ . \qquad ( 84 )$$

This may be identified as the origin of the infinities in Wilson renormalization. Furthermore, for many cases Γ≳1. To address these two problems, embodiments may employ the mathematically illogical process of Wilson renormalization which “solves the Renormalization Group Equations” for Sₘ. Such an embodiment may essentially reverse the perturbation expansion, that is Aₙ→Sₘ.

Turing to how the HST “solves the RGEs”, in some embodiments, the RGEs can be written as

$$\frac{d ( ln Z ( Λ ) )}{d ( ln Λ )} = - C ( Λ ) , \qquad ( 85 )$$

where Λ is the inverse scale, Z_{Λ} (J)=e^{iS} is the partition functional, and C(Λ) is the scale coupling function. Identifying the canonical derivative as

$$i d ( ln ) ∼ i {ψ}_{p} ★ ln {R}_{0} ∼ \frac{i d ( ln )}{d ( ln Λ )} , \qquad ( 86 )$$

how the HST is finding the solution to the RGEs, that is Eq. (85), is apparent. In summary, in such an embodiment, the HST is based on a canonical (e.g., Heisenberg) approach, in contrast to Lagrangian (e.g., Schrodinger or Feynman path integral perturbation expansion of e^{i∫λ}^{¹}=e_{iS}, where λ¹ is the Poincaré one-form or Lagrangian) approach with the need for a Wilson renormalization.

### EXAMPLE EMBODIMENTS

In some embodiments, techniques described herein are employed in complex system design and operation, including stabilization of a laser driven nuclear fusion reactor. In such an embodiment, it may be desirable to generate design parameters for a target to optimize performance, including how the target will be driven by the laser. Moreover, it may be desirable for the laser to be stabilized to disruption by laser plasma interactions (LPI).

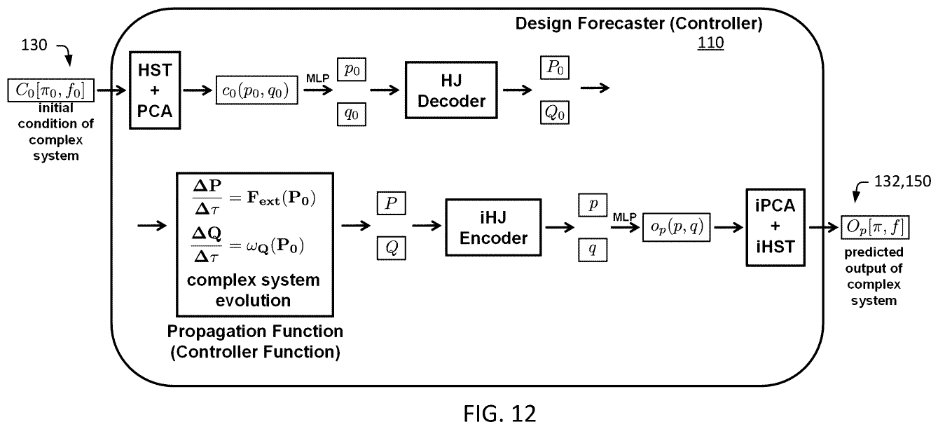

Concerning the generation of design parameters for the target to optimize performance, this may involve determining a set of initial conditions, including boundary conditions or similar parameters. FIG. 12 is a diagram that illustrates an example embodiment of operational aspects of the controller 110 of the complex system 101 in accordance with one or more embodiments. The illustrated embodiment shows operational aspects of the controller 110 (e.g., operating as a design forecaster) to generate output data 132 that includes a simulation 150 that includes a prediction of an output of the complex system 101 based on input data 130 that includes initial conditions for the controlled system 116, including initial boundary conditions. Referring to FIG. 12 (which is a diagram that illustrates an example embodiment of operational aspects a controller of a complex system, including design forecaster, in accordance with one or more embodiments), the controller 110 may, for example, perform the following operations:
1. setting the initial and boundary condition functional of the field and the co-field functions, C₀ [π₀ (x), ∫₀ (x)] (e.g., based on input data 130 that includes initial conditions of the complex system 101, including initial boundary conditions),
2. transforming the initial and boundary condition, using the Heisenberg scattering transformation (HST) and a principal component analysis projection (PCA), from a functional of the field and co-field functions to a function of the basic state and co-state variables, C₀ [π₀ (x), ƒ₀ (x)]→c₀ (p₀, q₀),
3. transforming from the initial condition function to the basic state and co-state variables, using a multi-layer perceptron (MLP) with ReLU activation, co (p₀, q₀)→(p₀, q₀),
4. transforming from the basic state and co-state variables to the fundamental state and co-state variables, using the transformation generated by the solution of the Hamilton-Jacobi equation (HJ), (p₀, q₀)→(P₀, Q₀),
5. propagating the fundamental state and co-state variables using Eqns. (45) and (46), (P₀, Q₀)→(P,Q),
6. transforming from the fundamental variables to the basic variables using the iHJ transformation, (P, Q)→(p,q),
7. transforming from the basic variables to the output function of the basic variables using a MLP with ReLU, (p,q)→oₚ (p,q),
8. transforming from the output function of basic variables to the output functional of the field and co-field functions using the iPCA and the iHST, oₚ (p, q)→Oₚ [π(x), ∫(x)], and
9. outputting the predicted output functional of the complex system, Oₚ [π(x), ƒ(x)] (e.g., including a simulation 150 that includes a predicted output of the complex system 101, such as performance of the controlled system 116).
   As noted, such as embodiment may be referred to as a design forecaster implementation of the controller 110. The input data 130 may include a field model that is the initial conditions and the output data 132 (e.g., including a simulation 150) may include a field model that is the resulting field evolution of the above described process. The complex transformer may be HST+PCA followed by MLP with ReLU. The fundamental transformer may be the HJ decoder. The controller function may be the propagation function, such as that given by Eqns. (45) and (46). In the context of a laser driven nuclear fusion reactor, such a design forecaster controller 110 may, for example, be used to design both the target geometry and the laser drive by methods of Bayesian experimental design. In such an embodiment, the input device 112 may be a computer that calculates radiation hydrodynamic simulations of the plasma with laser propagation through the plasma using the LLNL computer code Hydra, and provides that information as input data 130. The output device 114 may be a target fabricator and the NIF laser at LLNL and provides that information for use in simulation of the laser driven nuclear fusion reactor controlled system 116.

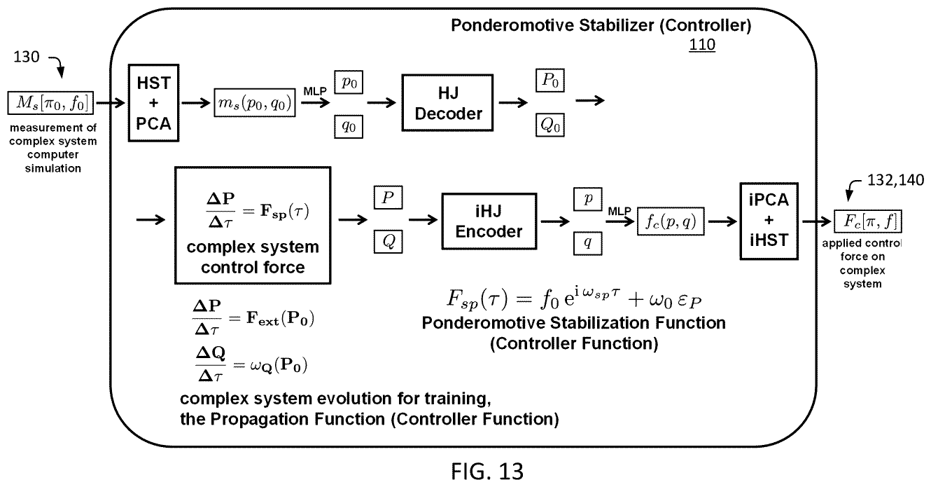

In some embodiments, techniques described herein are employed in operational control, such as the operational stabilization of the laser of a laser driven nuclear fusion reactor to disruption by LPI. FIG. 13 is a diagram that illustrates an example embodiment of the controller 110 of the complex system 101 in accordance with one or more embodiments. The illustrated embodiment illustrates operational aspects of the controller 110 (e.g., operating as a ponderomotive stabilizer) to generate output data 132 that includes system control parameters 140 that include a control force to be applied to the controlled system 116 of the complex system 101 that are determined based on input data 130 that includes measurements of the complex system 101, such as measurements from sensors or a simulation 150 of the complex system 101. Referring to FIG. 13 (which is a diagram that illustrates an example embodiment of a controller of a complex system, the ponderomotive stabilizer, in accordance with one or more embodiments), the controller 110 may, for example, perform the following operations:
1. making a measurement of a computer simulated functional of the field and the co-field functions, Mₛ [π₀ (x), ƒ₀ (x)] (e.g., which may be provided as part of input data 130 provided by way of control input device 112),
2. transforming the measurement, using the Heisenberg scattering transformation (HST) and a principal component analysis projection (PCA), from a functional of the field and co-field functions to a function of the basic state and co-state variables, Mₛ [π₀ (x), ƒ₀ (x)]→mₛ (p₀, q₀),
3. transforming from the measurement function to the basic state and co-state variables, using a multi-layer perceptron (MLP) with ReLU activation, mₛ (p₀, q₀)→(p₀, q₀) (optional),
4. transforming from the basic state and co-state variables to the fundamental state and co-state variables, using the transformation generated by the solution of the Hamilton-Jacobi equation (HJ), (p₀, q₀)→ (P₀, Q₀),
5. calculating the control force to be applied using Eq. (62) or Eqns. (45) and (46) when training, (P₀, Q₀)→(P, Q),
6. transforming from the fundamental variables to the basic variables using the iHJ transformation, (P, Q)→(p,q),
7. transforming from the basic variables to the control function of the basic variables using a MLP with ReLU, (p,q)→ƒ_{c} (p,q),
8. transforming from the control function of basic variables to the control functional of the field and co-field functions using the iPCA and the iHST, ƒ_{c} (p, q)→F_{c} [π(x), ƒ(x)], and
9. applying the control functional to the complex system, F_{c} [π(x), ƒ(x)] (e.g., which may be provided in system control parameters 140 of output data 132 to indicate a control force to be applied to the controlled system 116 of the complex system 101, which may, in turn, be interpreted and applied to the controlled system 116 by a control output device 114 to effectively control operations of the controlled system 116).
   As noted, such an embodiment may be referred to as a ponderomotive stabilizer implementation of the controller 110. The input data 130 may include a field model provided by control input device 112 (e.g., as part of the output of computer simulations of the laser propagation through the plasma, measurements of operations of the a laser driven nuclear fusion reactor of the controlled system 116 provided by sensors, or the like). The output data 132 may include a field model that is parameters for operating the laser driven nuclear fusion reactor of the controlled system 116, such as a desired profile of the laser field to be applied by control output device 114 or other entities that control operations of the laser driven nuclear fusion reactor of the controlled system 116. The complex transformer may be HST+PCA followed by MLP with ReLU. The fundamental transformer may be the HJ decoder. The controller function may be the ponderomotive stabilization function, such as that given by Eq. (62). The controller function for training may be the propagation function, given by Eqns. (45) and (46). The input device 112 may be a computer that calculates laser propagation through the plasma with the LLNL computer code pF3D and provides that information as input data 130. The output device 114 may be the NIF laser at LLNL that applies the control functional to the laser driven nuclear fusion reactor of the controlled system 116 of the complex system 101.

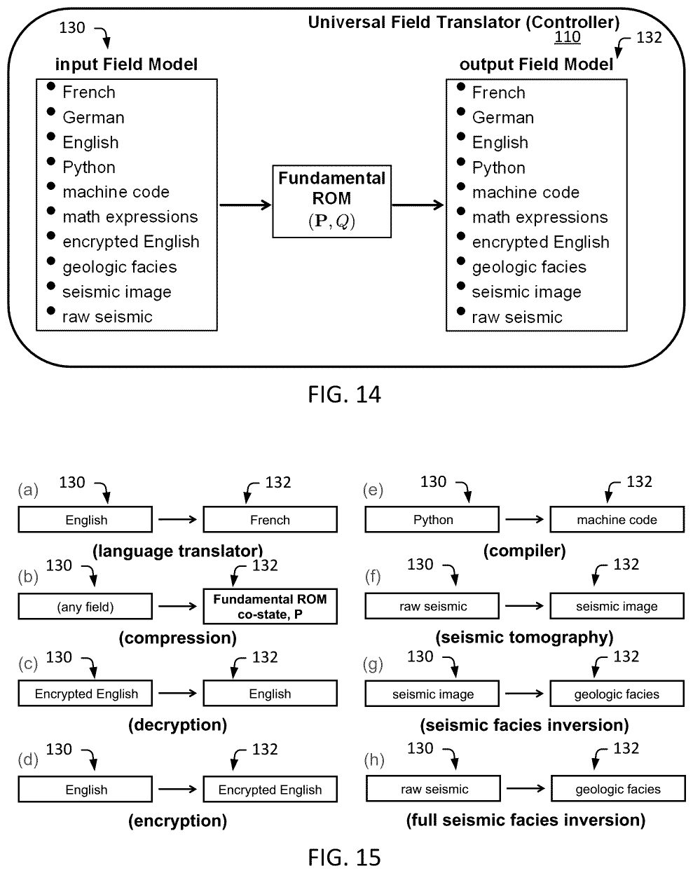

In some embodiments, techniques described herein are employed in translation operations, such as translation of data from one form to another, such as from one language to another language. In such an embodiment, the controller function for the translation controller 110 may be the propagation function. The input data 130 may include, for example, a field model having one of the following types: (1) French, (2) German, (3) English, (4) Python, (5) machine code, (6) math expressions, (7) encrypted English, (8) a geologic facies image, (9) a seismic image, or (10) raw seismic data. In such an embodiment, the form of the translator will take one of the input field model type, translate it into a universal and minimal reduced order model (ROM), the fundamental ROM, then translate it to another field model type. FIG. 14 is a diagram that illustrates a universal field translator (UFT) in accordance with one or more embodiments. The illustrated embodiment depicts a family of example embodiments of a controller 110 operable as a UFT. FIG. 15 is a diagram that illustrates example embodiments of a UFT in accordance with one or more embodiments. The illustrated embodiment shows various types of input data 130 and corresponding output data 132. As illustrated, the UFT type controller 110 may function to perform one or more of the following: (a) language translation, (b) optimal field compression, (c) decryption, (d) encryption, (e) compiling (f) seismic tomography, (g) seismic facies inversion, or (h) full seismic facies inversion.

With respect to the controller 110 of the complex system 101, a practical application may include, for example, a control unit with inputs communicatively coupled to input devices 112, such as sensors making measurements on the complex system 101, such as design and operational characteristics of the controlled system 116, and outputs communicatively coupled to output devices 114, such as actuators operable to applying a force to the controlled system 116 of the complex system 101. An actuator may include a component that can be employed to impart control of one or more aspects of operation of a complex system. In the case of a car, for example, the input sensors could be cameras, proximity sensors, speedometers, and tachometers, or the like. The actuators could be the accelerator, the steering wheel, and the brakes, or the like. In the case of a video game, the input could be the game display or the like. The actuators could be the joystick and buttons, or the like. In the case of an economy or financial systems, the inputs could be measurements of economic activity and prices, or the like. The actuators could be investment and arbitrage trading, or the like.

With respect to design forecaster operations of the controller 110 of the complex system 110, a practical application may include, for example, a physical system that includes a control unit with inputs communicatively coupled to input devices 112, such as sensors that measure the initial conditions for the complex system 101, including the controlled system 116, and outputs communicating coupled to output devices 114, such as a display or other user interface to present the predicted outputs, such as a generated simulation 150. For the case of a car, for example, the inputs could be sensors of the accelerator, steering wheel and the brakes, or the like. The outputs could be displays of the speedometers, tachometers and videos, or the like. In the case of video games, the inputs could be the joystick and buttons, or the like. The output could be the video display or the like. In the case of an economy of financial systems, the inputs could be the investment and the arbitrage trading, or the like. The output could be a display of the economic performance and prices, or the like. In some embodiments, a design forecaster operation is performed by the controller 110 to determine what the initial condition should be to obtain a desired output. The initial condition of the associated controlled system 116, for example, then can be set to that value to obtain the desired output. In some embodiments, the design forecaster operation could, for example, automatically search (invert) to find the initial condition that gives the desired output.

With respect to the UFT operations of the controller 110, a practical application may include, for example, a physical system that includes a control unit communicatively coupled to input devices 112, such as a keyboard, or the like, and communicatively coupled to output devices 112, such as a printer, or the like. In a language translation embodiment, English, or the like, could be typed at the keyboard, then French or Encrypted English, or the like, could generated by the controller UFT operations and be printed at the printer, or the like. Another practical application may include, for example, a physical system that includes control unit communicatively coupled to input devices 112, such as seismic geophones, or the like, and communicatively coupled to output devices 112, such as a printer, or the like. Reflected seismic waves, or the like, could be sensed by the geophones, or the like, then an image of the earth, or the like, could be generated by the controller UFT operations and be printed by the printer, or the like.

Provided in some embodiments are systems, methods or mediums for providing embodiments described here. For example, embodiments may include a system having a control system, such as a computer, comprising a processor (e.g., one or more processors) and non-transitory computer readable storage medium comprising program instruction stored thereon that are executable by the processor to cause operations described here. As another example, embodiments may include a method performing operations described here. As yet another example, embodiments may include a non-transitory computer readable storage medium comprising program instruction stored thereon that are executable by a processor to cause operations described here.

FIG. 16 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to the entities described (e.g., the system controller 110, one or more control input devices 112, one or more control output devices 114, the controlled system 116, or the control engine 120), operational aspects of environment 100, or the methods described, including operations described with regard to FIGS. 1-15.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A system for controlling a complex system comprising:
a processor; and
non-transitory computer readable storage medium comprising program instruction stored thereon that are executable by the processor to cause the following operations:
obtaining an input of a functional of field and co-field functions;
determining, based on the input functional and using a canonical functional transformation determined by a generating functional, an input function, the input function comprising a function of input basic state and co-state variables;
determining, based on the input function and using a function transformation, the input basic state and co-state variables;
determining, based on the input basic state and co-state variables and using a canonical transformation determined by a generating function that is a solution to a Hamilton-Jacobi equation, input fundamental state and co-state variables;
determining, based on the input fundamental state and co-state variables and using a control function transformation, output fundamental state and co-state variables;
determining, based on the output fundamental state and co-state variables and using an inverse canonical transformation determined by a generating function that is a solution to the Hamilton-Jacobi equation, output basic state and co-state variables;
determining, based on the output basic state and co-state variables and using a function transformation, the output function, the output function comprising a function of output basic state and co-state variables; and
determining, based on the output function and using an inverse canonical functional transformation determined by a generating functional, an output functional of the field and co-field functions,
wherein a complex system operation is controlled based on the output functional of field and co-field functions.

2. The system of claim 1,
wherein the canonical functional transformation determined by a generating functional comprises: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection;
wherein the function transformations comprise: (1) a specified formula for a function; (2) a universal function approximator; or (3) a multi-layer perceptron (MLP) with rectified linear unit (ReLU) activation;
wherein the canonical transformation determined by a generating function that is a solution to a Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder;
wherein the control function transformation comprises: (1) a specified formula for a function; (2) a universal function approximator; (3) a multi-layer perceptron (MLP) with rectified linear unit (ReLU) activation; (4) a propagation function configured to evolve the complex system; (5) a ponderomotive stabilization function configured to stabilize unstable equilibriums of the complex system; (6) a feedback control function configured to stabilize unstable equilibriums of the complex system; (7) a conservative force function configured to optimize design of the complex system; or (8) a diffusive function configured to reduce fluctuations of the complex system;
wherein the inverse canonical transformation determined by a generating function that is a solution to the Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder; and
wherein the inverse canonical functional transformation determined by a generating functional comprises: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).

3. The system of claim 1, wherein the canonical functional transformation determined by a generating functional comprises: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection.

4. The system of claim 1, wherein the function transformations comprise: (1) a specified formula for a function; (2) a universal function approximator; or (3) a multi-layer perceptron (MLP) with rectified linear unit (ReLU) activation.

5. The system of claim 1, wherein the canonical transformation determined by a generating function that is a solution to a Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder.

6. The system of claim 1, wherein the control function transformation comprises: (1) a specified formula for a function; (2) a universal function approximator; (3) a multi-layer perceptron (MLP) with rectified linear unit (ReLU) activation; (4) a propagation function configured to evolve the complex system; (5) a ponderomotive stabilization function configured to stabilize unstable equilibriums of the complex system; (6) a feedback control function configured to stabilize unstable equilibriums of the complex system; (7) a conservative force function configured to optimize performance of the complex system; or (8) a diffusive function configured to reduce fluctuations of the complex system.

7. The system of claim 1, wherein the inverse canonical transformation determined by a generating function that is a solution to the Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder.

8. The system of claim 1, wherein the inverse canonical functional transformation determined by a generating functional comprises: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).

9. A method of controlling a complex system comprising:
obtaining an input of a functional of field and co-field functions;
determining, based on the input functional and using a canonical functional transformation determined by a generating functional, an input function, the input function comprising a function of input basic state and co-state variables;
determining, based on the input function and using a function transformation, the input basic state and co-state variables;
determining, based on the input basic state and co-state variables and using a canonical transformation determined by a generating function that is a solution to a Hamilton-Jacobi equation, input fundamental state and co-state variables;
determining, based on the input fundamental state and co-state variables and using a control function transformation, output fundamental state and co-state variables;
determining, based on the output fundamental state and co-state variables and using an inverse canonical transformation determined by a generating function that is a solution to the Hamilton-Jacobi equation, output basic state and co-state variables;
determining, based on the output basic state and co-state variables and using a function transformation, the output function, the output function comprising a function of output basic state and co-state variables; and
determining, based on the output function and using an inverse canonical functional transformation determined by a generating functional, an output functional of the field and co-field functions,
wherein a complex system operation is controlled based on the output functional of field and co-field functions.

10. The method of claim 9,
wherein the canonical functional transformation determined by a generating functional comprises: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection;
wherein the function transformations comprise: (1) a specified formula for a function; (2) a universal function approximator; or (3) a multi-layer perceptron (MLP) with rectified linear unit (ReLU) activation;
wherein the canonical transformation determined by a generating function that is a solution to a Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder;
wherein the control function transformation comprises: (1) a specified formula for a function; (2) a universal function approximator; (3) a multi-layer perceptron (MLP) with rectified linear unit (ReLU) activation; (4) a propagation function configured to evolve the complex system; (5) a ponderomotive stabilization function configured to stabilize unstable equilibriums of the complex system; (6) a feedback control function configured to stabilize unstable equilibriums of the complex system; (7) a conservative force function configured to optimize design of the complex system; or (8) a diffusive function configured to reduce fluctuations of the complex system;
wherein the inverse canonical transformation determined by a generating function that is a solution to the Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder; and
wherein the inverse canonical functional transformation determined by a generating functional comprises: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).

11. The method of claim 9, wherein the canonical functional transformation determined by a generating functional comprises: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection.

12. The method of claim 9, wherein the function transformations comprise: (1) a specified formula for a function; (2) a universal function approximator; or (3) a multi-layer perceptron (MLP) with rectified linear unit (ReLU) activation.

13. The method of claim 9, wherein the canonical transformation determined by a generating function that is a solution to a Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder.

14. The method of claim 9, wherein the control function transformation comprises: (1) a specified formula for a function; (2) a universal function approximator; (3) a multi-layer perceptron (MLP) with rectified linear unit (ReLU) activation; (4) a propagation function configured to evolve the complex system; (5) a ponderomotive stabilization function configured to stabilize unstable equilibriums of the complex system; (6) a feedback control function configured to stabilize unstable equilibriums of the complex system; (7) a conservative force function configured to optimize performance of the complex system; or (8) a diffusive function configured to reduce fluctuations of the complex system.

15. The method of claim 9, wherein the inverse canonical transformation determined by a generating function that is a solution to the Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder.

16. The method of claim 9, wherein the inverse canonical functional transformation determined by a generating functional comprises: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).

17. A non-transitory computer readable storage medium comprising program instruction stored thereon that are executable by the processor to cause the following operations for controlling a complex system:
obtaining an input of a functional of field and co-field functions;
determining, based on the input functional and using a canonical functional transformation determined by a generating functional, an input function, the input function comprising a function of input basic state and co-state variables;
determining, based on the input function and using a function transformation, the input basic state and co-state variables;
determining, based on the input basic state and co-state variables and using a canonical transformation determined by a generating function that is a solution to a Hamilton-Jacobi equation, input fundamental state and co-state variables;
determining, based on the input fundamental state and co-state variables and using a control function transformation, output fundamental state and co-state variables;
determining, based on the output fundamental state and co-state variables and using an inverse canonical transformation determined by a generating function that is a solution to the Hamilton-Jacobi equation, output basic state and co-state variables;
determining, based on the output basic state and co-state variables and using a function transformation, the output function, the output function comprising a function of output basic state and co-state variables; and
determining, based on the output function and using an inverse canonical functional transformation determined by a generating functional, an output functional of the field and co-field functions,
wherein a complex system operation is controlled based on the output functional of field and co-field functions.

18. The medium of claim 17,
wherein the canonical functional transformation determined by a generating functional comprises: (1) a specified formula for a functional; (2) a universal functional approximator; (3) a convolutional neural network (CNN); (4) a universal functional approximator constrained to canonical structure; or (5) a Heisenberg scattering transformation (HST) followed by a principal components analysis (PCA) projection;
wherein the function transformations comprise: (1) a specified formula for a function; (2) a universal function approximator; or (3) a multi-layer perceptron (MLP) with rectified linear unit (ReLU) activation;
wherein the canonical transformation determined by a generating function that is a solution to a Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) decoder;
wherein the control function transformation comprises: (1) a specified formula for a function; (2) a universal function approximator; (3) a multi-layer perceptron (MLP) with rectified linear unit (ReLU) activation; (4) a propagation function configured to evolve the complex system; (5) a ponderomotive stabilization function configured to stabilize unstable equilibriums of the complex system; (6) a feedback control function configured to stabilize unstable equilibriums of the complex system; (7) a conservative force function configured to optimize design of the complex system; or (8) a diffusive function configured to reduce fluctuations of the complex system;
wherein the inverse canonical transformation determined by a generating function that is a solution to the Hamilton-Jacobi equation comprises: (1) a specified formula for a function; (2) a universal function approximator; (3) a multi-layer perceptron (MLP) with rectified linear unit (ReLU) activation; (4) a universal function approximator constrained to canonical structure; or (5) a Hamilton-Jacobi (HJ) encoder; and
wherein the inverse canonical functional transformation determined by a generating functional comprises: (1) a specified formula for a functional; (2) a universal inverse functional approximator; (3) an inverse convolutional neural network (iCNN); (4) a universal inverse functional approximator constrained to canonical structure; or (5) an inverse principal components analysis (iPCA) projection followed by an inverse Heisenberg scattering transformation (iHST).
